(19) United States
(12) Patent Application Publication
(10) Pub. No.: US 2025/0252899 A1
(43) Pub. Date: Aug. 7, 2025

(54) DISPLAY DEVICE, AND METHOD OF OPERATING A DISPLAY DEVICE

(71) Applicant: Samsung Display Co., LTD., Yongin-si (KR)

(72) Inventor: KYUNG-HUN LEE, Yongin-si (KR)

(21) Appl. No.: 18/951,377

(22) Filed: Nov. 18, 2024

(30) Foreign Application Priority Data
Feb. 7, 2024 (KR) 10-2024-0019218

(51) Int. Cl. G09G 3/32

(52) U.S. Cl. CPC G09G 3/32; G09G 2310/061; G09G 2340/0435

(57) ABSTRACT

A display device includes: a display panel including a plurality of pixels; and a panel driver to drive the display panel at a variable frame frequency, and to: in an active period of a frame period, perform an active scan operation to initialize light emitting elements of the plurality of pixels, while providing data voltages to the plurality of pixels, and in a blank period of the frame period, perform an initialization scan operation to initialize the light emitting elements without providing the data voltages to the plurality of pixels. A time interval from a start time point of the frame period to a time point at which the initialization scan operation is performed is different from a time length of a minimum frame period corresponding to a maximum frame frequency of the variable frame frequency.

### CROSS-REFERENCE TO RELATED APPLICATION(S)

The present application claims priority to and the benefit of Korean Patent Application No. 10-2024-0019218, filed on Feb. 7, 2024, in the Korean Intellectual Property Office (KIPO), the entire disclosure of which is incorporated by reference herein.

### BACKGROUND

### 1. Field

Aspects of embodiments of the present disclosure relate to a display device, and more particularly, to a display device that drives a display panel at a variable frame frequency, and a method of operating the display device.

### 2. Description of the Related Art

In general, a display device may display an image at a constant frame frequency (or a constant frame rate) of about 60 Hz, about 120 Hz, about 240 Hz, or the like. However, a frame frequency for rendering by a host processor (e.g., a graphics processing unit (GPU), an application processor (AP), or a graphics card) for providing frame data to the display device may be different from the frame frequency of the display device. For example, when the host processor provides the display device with frame data for a game image (e.g., a gaming image) that uses complicated rendering, the frame frequency mismatch may be intensified, and a tearing phenomenon may occur where a boundary line is caused by the frame frequency mismatch in an image of the display device.

The above information disclosed in this Background section is for enhancement of understanding of the background of the present disclosure, and therefore, it may contain information that does not constitute prior art.

### SUMMARY

To prevent or reduce the tearing phenomenon, a variable frame mode (e.g., Free-Sync, G-Sync, and the like) has been developed in which a host processor provides frame data to a display device at a variable frame frequency by changing a time length (e.g., a duration of time) of a blank period in each frame period. A display device supporting the variable frame mode may display an image in synchronization with the variable frame frequency, or may drive a display panel at the variable frame frequency or a variable driving frequency, thereby reducing or preventing the tearing phenomenon.

Some embodiments of the present disclosure may be directed to a display device capable of removing or reducing a luminance deviation due to a variation in a variable frame frequency.

Some embodiments of the present disclosure may be directed to a method of operating a display device capable of removing or reducing a luminance deviation due to a variation in a variable frame frequency.

According to one or more embodiments of the present disclosure, a display device includes: a display panel including a plurality of pixels; and a panel driver configured to drive the display panel at a variable frame frequency, and to: in an active period of a frame period, perform an active scan operation to initialize light emitting elements of the plurality of pixels, while providing data voltages to the plurality of pixels, and in a blank period of the frame period, perform an initialization scan operation to initialize the light emitting elements without providing the data voltages to the plurality of pixels. A time interval from a start time point of the frame period to a time point at which the initialization scan operation is performed is different from a time length of a minimum frame period corresponding to a maximum frame frequency of the variable frame frequency.

In an embodiment, the active period may have a constant time length, and the blank period may include a default blank period when the variable frame frequency is the maximum frame frequency, and the blank period may include the default blank period and an additional blank period when the variable frame frequency is lower than the maximum frame frequency.

In an embodiment, when the variable frame frequency is lower than the maximum frame frequency, the panel driver may be configured to not perform the initialization scan operation at a start time point of the additional blank period.

In an embodiment, when the variable frame frequency is lower than the maximum frame frequency, the panel driver may be configured to perform the initialization scan operation after a time has lapsed from a start time point of the additional blank period.

In an embodiment, a cycle of the initialization scan operation within the blank period may not be constant.

In an embodiment, the panel driver may be configured to determine blank initialization time points at which the initialization scan operation may be performed within the blank period to reduce a variation in a number of times the light emitting elements are initialized per unit time as the variable frame frequency changes.

In an embodiment, the maximum frame frequency may be 360 Hz, a first blank initialization time point at which the initialization scan operation is first performed from among the blank initialization time points may correspond to a frame frequency between 230 Hz and 240 Hz, a second blank initialization time point at which the initialization scan operation is performed for a second time from among the blank initialization time points may correspond to a frame frequency between 140 Hz and 150 Hz, a third blank initialization time point at which the initialization scan operation is performed for a third time from among the blank initialization time points may correspond to a frame frequency between 110 Hz and 120 Hz, a fourth blank initialization time point at which the initialization scan operation is performed for a fourth time from among the blank initialization time points may correspond to a frame frequency between 80 Hz and 90 Hz, and a fifth blank initialization time point at which the initialization scan operation is performed for a fifth time from among the blank initialization time points may correspond to a frame frequency between 60 Hz and 70 Hz.

In an embodiment, the blank initialization time points may be adjusted by measuring a luminance of the display panel.

In an embodiment, each of the plurality of pixels may include: a capacitor including a first electrode connected to a gate node, and a second electrode connected to a source node; a first transistor including a gate connected to the gate node, a drain configured to receive a first power supply voltage, and a source connected to the source node; a second transistor configured to transfer a data voltage to the gate node in response to a scan signal; a third transistor configured to transfer an initialization voltage to the source node in response to an initialization signal; and a corresponding light emitting element from among the light emitting elements including an anode connected to the source node, and a cathode configured to receive a second power supply voltage.

In an embodiment, to perform the active scan operation in the active period, the panel driver may be configured to provide the scan signal and the initialization signal to each of the plurality of pixels, and to perform the initialization scan operation in the blank period, the panel driver may be configured to provide the initialization signal to each of the plurality of pixels without providing the scan signal.

In an embodiment, the panel driver may include: a frame counter configured to count a duration of the frame period; and a blank initialization storage configured to store blank initialization time points at which the initialization scan operation is performed within the blank period, and the panel driver may be configured to perform the initialization scan operation when the duration of the frame period counted by the frame counter corresponds to the blank initialization time points stored in the blank initialization storage.

In an embodiment, the blank initialization storage may be further configured to store initialization voltage levels corresponding to the blank initialization time points, respectively, and the panel driver may be configured to adjust an initialization voltage applied to the plurality of pixels based on the initialization voltage levels stored in the blank initialization storage when the duration of the frame period counted by the frame counter corresponds to the blank initialization time points stored in the blank initialization storage.

According to one or more embodiments of the present disclosure, a method of operating a display device to drive a display panel including a plurality of pixels at a variable frame frequency, includes: performing an active scan operation in an active period of a frame period to initialize light emitting elements of the plurality of pixels, while providing data voltages to the plurality of pixels; and performing an initialization scan operation in a blank period of the frame period to initialize the light emitting elements without providing the data voltages to the plurality of pixels. A time interval from a start time point of the frame period to a time point at which the initialization scan operation is performed may be different from a time length of a minimum frame period corresponding to a maximum frame frequency of the variable frame frequency.

In an embodiment, the active period may have a constant time length, and the blank period may include a default blank period when the variable frame frequency is the maximum frame frequency, and the blank period may include the default blank period and an additional blank period when the variable frame frequency is lower than the maximum frame frequency.

In an embodiment, when the variable frame frequency is lower than the maximum frame frequency, the initialization scan operation may not be performed at a start time point of the additional blank period.

In an embodiment, a cycle of the initialization scan operation within the blank period may not be constant.

In an embodiment, the performing of the initialization scan operation in the blank period may include: counting a duration of the frame period; skipping the initialization scan operation when the duration of the frame period is equal to the time length of the minimum frame period; and performing the initialization scan operation when the duration of the frame period is greater than or equal to K times of the time length of the minimum frame period, where K is an integer greater than 1.

In an embodiment, the method may further include determining blank initialization time points at which the initialization scan operation is performed within the blank period to reduce a variation in a number of times the light emitting elements are initialized per unit time as the variable frame frequency changes.

In an embodiment, the blank initialization time points may be adjusted by measuring a luminance of the display panel.

In an embodiment, the performing of the initialization scan operation in the blank period may include: counting a duration of the frame period; and performing the initialization scan operation when the duration of the frame period corresponds to the blank initialization time points.

According to some embodiments of the present disclosure, in a display device and a method of operating the display device, a display panel may be driven at a variable frame frequency, an active scan operation may be performed in an active period of a frame period, and an initialization scan operation may be performed in a blank period of the frame period. A time interval from a start time point of the frame period to a time point at which the initialization scan operation is performed may be different from a time length of a minimum frame period corresponding to a maximum frame frequency of the variable frame frequency. Accordingly, a luminance deviation due to variation in the variable frame frequency may be removed or reduced.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a block diagram illustrating a display device according to one or more embodiments.

FIG. 2 is a circuit diagram illustrating an example of a pixel included in a display device according to one or more embodiments.

FIG. 3A is a diagram illustrating an example of a minimum frame period corresponding to a maximum frame frequency, and a maximum frame period corresponding to a minimum frame frequency.

FIG. 3B is a diagram illustrating an example of luminances of a display panel at the minimum frame frequency and the maximum frame frequency in a case where an initialization scan operation is not performed.

FIG. 4A is a timing diagram illustrating an example in which an active scan operation is performed in an active period, and an initialization scan operation is performed in a blank period.

FIG. 4B is a timing diagram illustrating an example of a luminance decrease according to a change of a variable frame frequency.

FIG. 5 is a timing diagram illustrating an example of an initialization scan operation in a blank period according to one or more embodiments.

FIG. 6 is a timing diagram illustrating an example of an initialization scan operation in a blank period according to one or more embodiments.

FIG. 7 is a flowchart illustrating a method of operating a display device according to one or more embodiments.

FIG. 8 is a table illustrating an example of a number of initialization scan operations in each frame period according to a variable frame frequency.

FIG. 9A is a table illustrating an example of a number of times a light emitting element is initialized per unit time according to a variable frame frequency.

FIG. 9B is a graph illustrating an example of a number of times a light emitting element is initialized per unit time according to a variable frame frequency.

FIG. 10A is a table illustrating an example of a luminance of a display panel according to a variable frame frequency.

FIG. 10B is a graph showing an example of a luminance of a display panel according to a variable frame frequency.

FIG. 11 is a flowchart illustrating a method of operating a display device according to one or more embodiments.

FIG. 12 is a table illustrating an example of a number of initialization scan operations in each frame period according to a variable frame frequency.

FIG. 13A is a table illustrating an example of a number of times a light emitting element is initialized per unit time according to a variable frame frequency.

FIG. 13B is a graph illustrating an example of a number of times a light emitting element is initialized per unit time according to a variable frame frequency.

FIG. 14A is a table illustrating an example of a luminance of a display panel according to a variable frame frequency.

FIG. 14B is a graph showing an example of a luminance of a display panel according to a variable frame frequency.

FIG. 15 is a block diagram illustrating an electronic device including a display device according to one or more embodiments.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

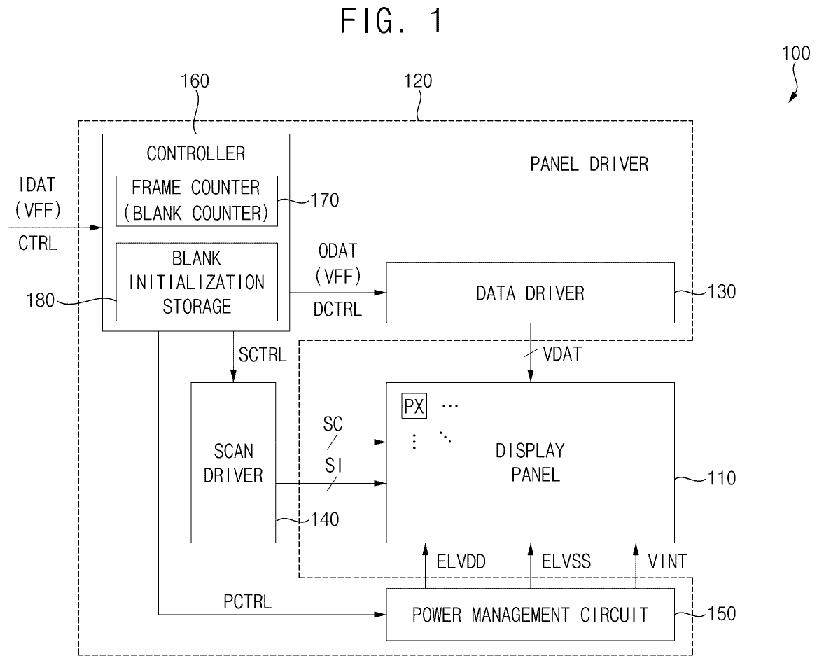

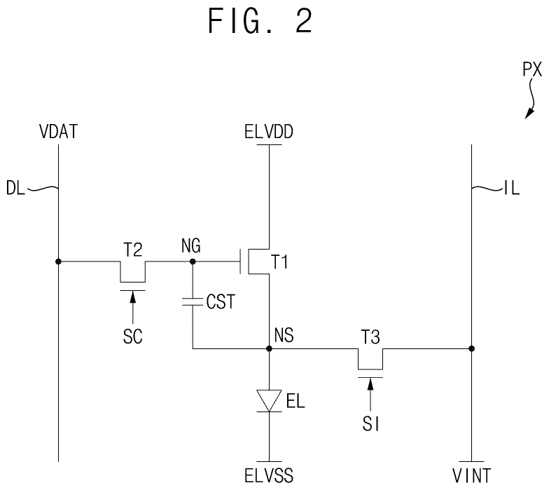

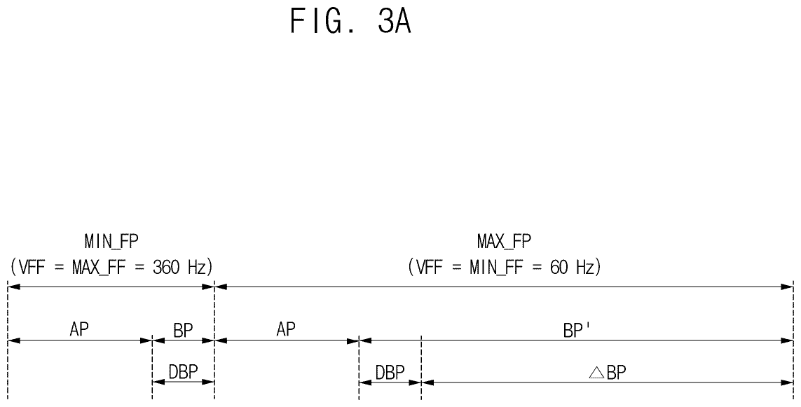

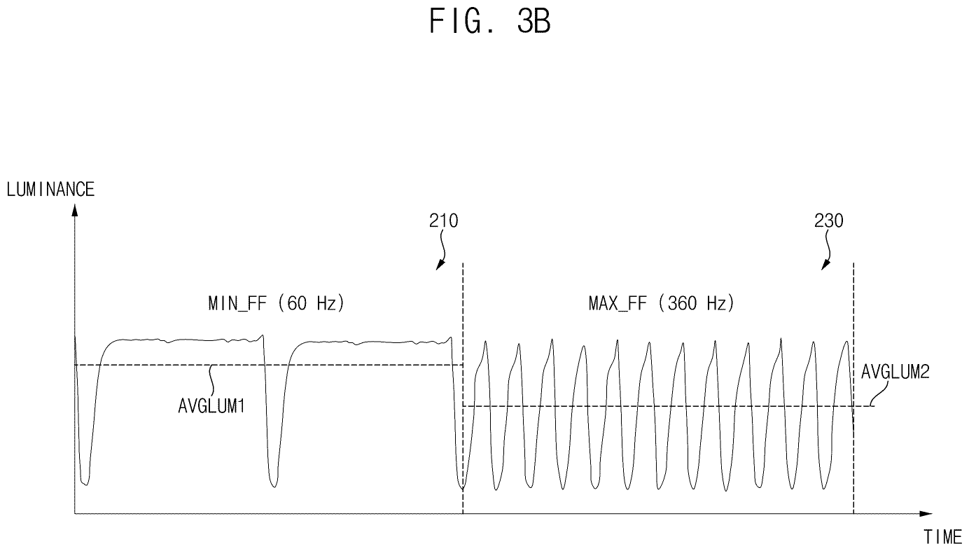

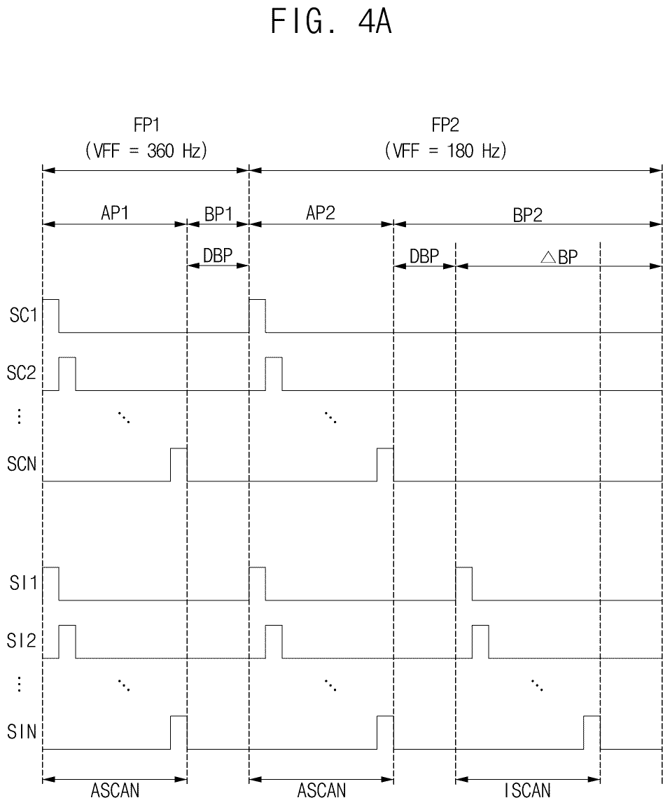

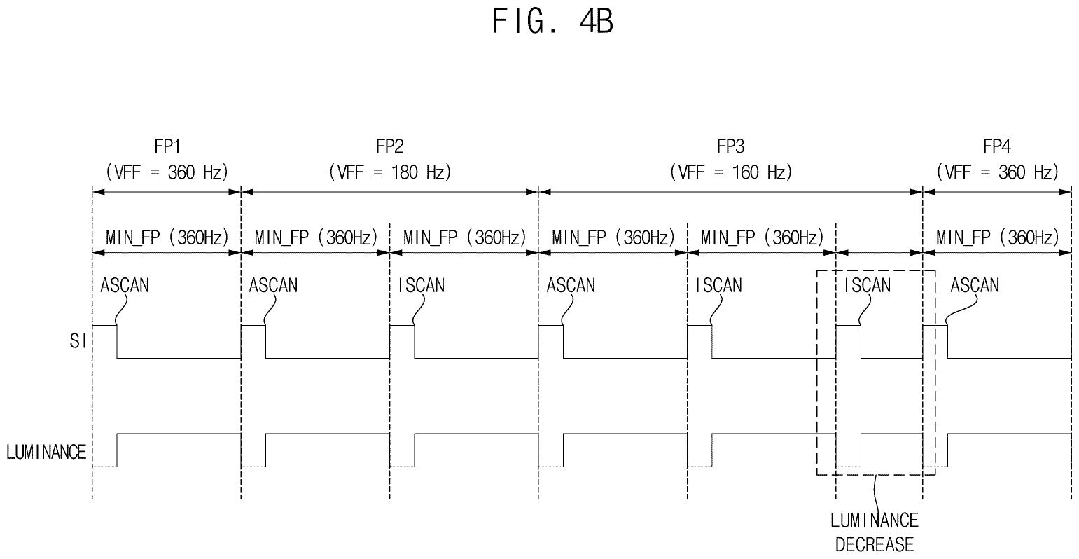

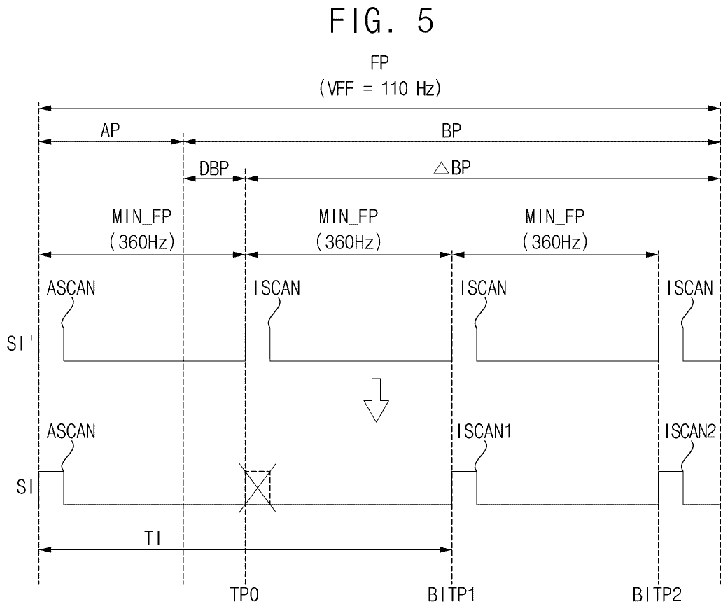

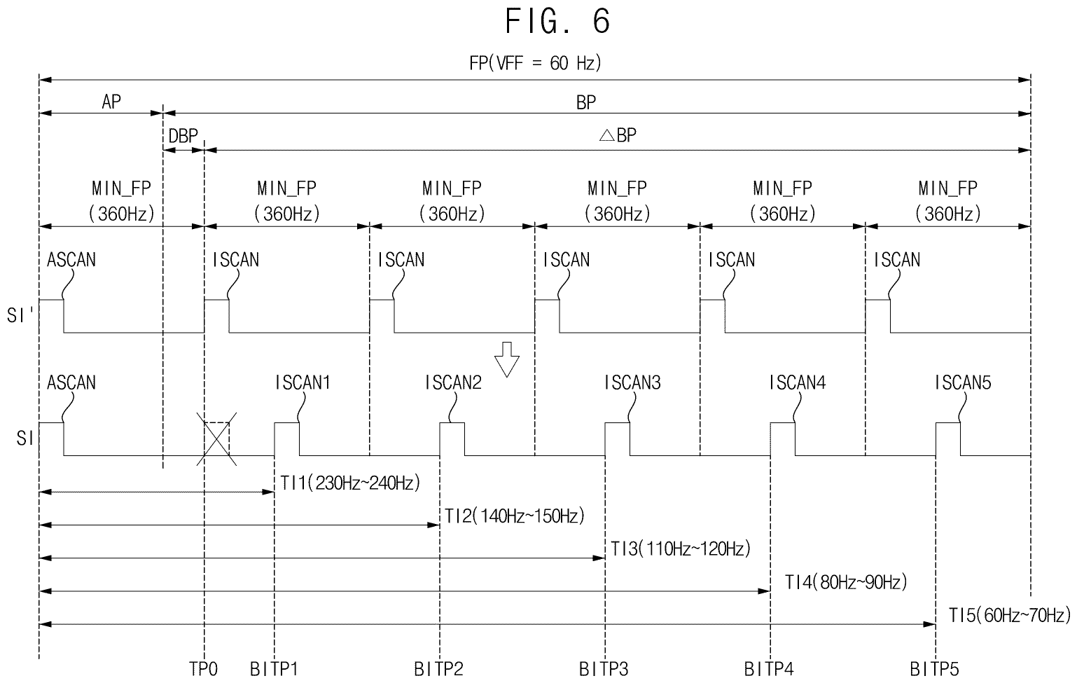

FIG. 1 is a block diagram illustrating a display device according to one or more embodiments. FIG. 2 is a circuit diagram illustrating an example of a pixel included in a display device according to one or more embodiments. FIG. 3A is a diagram illustrating an example of a minimum frame period corresponding to a maximum frame frequency, and a maximum frame period corresponding to a minimum frame frequency. FIG. 3B is a diagram illustrating an example of luminances of a display panel at the minimum frame frequency and the maximum frame frequency in a case where an initialization scan operation is not performed. FIG. 4A is a timing diagram illustrating an example in which an active scan operation is performed in an active period, and an initialization scan operation is performed in a blank period. FIG. 4B is a timing diagram illustrating an example of a luminance decrease according to a change of a variable frame frequency. FIG. 5 is a timing diagram illustrating an example of an initialization scan operation in a blank period according to one or more embodiments. FIG. 6 is a timing diagram illustrating an example of an initialization scan operation in a blank period according to one or more embodiments.

Referring to FIG. 1, a display device 100 according to one or more embodiments may include a display panel 110 that includes a plurality of pixels PX, and a panel driver 120 that drives the display panel 110. In some embodiments, the panel driver 120 may include a data driver 130 that provides data voltages VDAT to the plurality of pixels PX, a scan driver 140 that provides scan signals SC and initialization signals SI to the plurality of pixels PX, a power management circuit 150 that generates voltages ELVDD, ELVSS, and VINT, and a controller 160 that controls an operation of the display device 100.

The display panel 110 may include a plurality of data lines, a plurality of initialization lines, and the plurality of pixels PX connected thereto. In some embodiment, each pixel PX may include a light emitting element, and the display panel 110 may be a light emitting display panel.

For example, as illustrated in FIG. 2, each pixel PX may have a 3T1C (e.g., a 3 transistor-1 capacitor) structure including a first transistor T1, a second transistor T2, a third transistor T3, a capacitor CST, and a light emitting element EL.

The capacitor CST may store the data voltage VDAT transferred by the second transistor T2 from the data line DL. The capacitor CST may be referred to as a storage capacitor for storing the data voltage VDAT, but the present disclosure is not limited thereto. In some embodiments, the capacitor CST may include a first electrode connected to a gate node NG, and a second electrode connected to a source node NS.

The first transistor T1 may generate a driving current based on the data voltage VDAT stored in the capacitor CST. The first transistor T1 may be referred to as a driving transistor for generating the driving current, but the present disclosure is not limited thereto. In some embodiments, the first transistor T1 may include a gate connected to the gate node NG, a drain that receives a first power supply voltage ELVDD, and a source connected to the source node NS.

The second transistor T2 may transfer the data voltage VDAT of the data line DL to the gate node NG in response to the scan signal SC. The second transistor T2 may be referred to as a scan transistor, but the present disclosure is not limited thereto. In some embodiments, the second transistor T2 may include a gate that receives the scan signal SC, a drain connected to the data line DL, and a source connected to the gate node NG.

The third transistor T3 may connect the initialization line IL to the source node NS in response to the initialization signal SI. Thus, the third transistor T3 may transfer an initialization voltage VINT to the source node NS in response to the initialization signal SI. When the initialization voltage VINT is applied to the source node NS, the light emitting element EL (e.g., an anode of the light emitting element EL) may be initialized based on the initialization voltage VINT. When the light emitting element EL is initialized, the light emitting element EL may not emit light (e.g., may be turned off). In some embodiments, the initialization line IL may be used as a sensing line for sensing a characteristic of the pixel PX, but the present disclosure is not limited thereto. In some embodiments, the third transistor T3 may include a gate that receives the initialization signal SI, a drain connected to the source node NS, and a source connected to the initialization line IL.

The light emitting element EL may emit light in response to the driving current flowing from a line that transfers the first power supply voltage ELVDD to a line that transfers a second power supply voltage ELVSS. In some embodiments, the light emitting element EL may include an anode connected to the source node NS, and a cathode that receives the second power supply voltage ELVSS. In some embodiments, the light emitting element EL may be an organic light emitting diode OLED. In other embodiments, the light emitting element EL may be a nano light emitting diode (NED), a quantum dot (QD) light emitting diode, a micro light emitting diode, an inorganic light emitting diode, or any other suitable kind of light emitting element.

In some embodiments, as illustrated in FIG. 2, the first, second, and third transistors T1, T2, and T3 may be implemented as n-type metal oxide semiconductor (NMOS) transistors, but the present disclosure is not limited thereto. Further, although an example of the pixel PX having the 3T1C structure is illustrated in FIG. 2, the pixel PX according to embodiments of the present disclosure is not limited to the example illustrated in FIG. 2. Further, in other embodiments, the display panel 110 may be a Liquid Crystal Display (LCD) panel, or any other suitable kind of display panel.

The data driver 130 may generate the data voltages VDAT based on a data control signal DCTRL and output image data ODAT received from the controller 160, and may provide the data voltages VDAT to the plurality of pixels PX through the plurality of data lines. In some embodiments, the data control signal DCTRL may include, but is not limited to, an output data enable signal, a horizontal start signal, and a load signal. Further, in some embodiments, the data driver 130 may receive the output image data ODAT from the controller 160 at a variable frame frequency VFF (e.g., from about 60 Hz to about 360 Hz). In some embodiments, the data driver 130 and the controller 160 may be implemented together as a single integrated circuit, and the single integrated circuit may be referred to as a timing controller embedded data driver (TED) integrated circuit. In other embodiments, the data driver 130 and the controller 160 may implemented as separate integrated circuits.

The scan driver 140 may generate the scan signals SC and/or the initialization signals SI based on a scan control signal SCTRL received from the controller 160. The scan driver 140 may sequentially provide the scan signals SC and/or the initialization signals SI to the plurality of pixels PX on a row-by-row basis. In some embodiments, the scan control signal SCTRL may include, but is not limited to, a scan start signal and a scan clock signal. In some embodiments, the scan driver 140 may be integrated with or formed in the display panel 110. In other embodiments, the scan driver 140 may be implemented as one or more integrated circuits.

The power management circuit 150 may generate the voltages ELVDD, ELVSS, and VINT used for the operations of the display device 100. In some embodiments, the power management circuit 150 may generate the first power supply voltage ELVDD (e.g., a high power supply voltage), the second power supply voltage ELVSS (e.g., a low power supply voltage), and the initialization voltage VINT that are provided to the display panel 110. In some embodiments, the power management circuit 150 may be implemented as an integrated circuit, which may be referred to as a power management integrated circuit (PMIC). In other embodiments, the power management circuit 150 may be included in the controller 160 or the data driver 130.

The controller 160 (e.g., the timing controller (TCON)) may receive input image data IDAT and a control signal CTRL from an external host processor (e.g., a graphics processing unit (GPU), an application processor (AP), or a graphics card). In some embodiments, the input image data IDAT may be RGB image data including red image data, green image data, and blue image data. The control signal CTRL may include, but is not limited to, a vertical synchronization signal, a horizontal synchronization signal, an input data enable signal, and a master clock signal. The controller 160 may generate the output image data ODAT, the data control signal DCTRL, the scan control signal SCTRL, and a power management control signal PCTRL based on the input image data IDAT and the control signal CTRL. The controller 160 may control an operation of the data driver 130 by providing the output image data ODAT and the data control signal DCTRL to the data driver 130. The controller 160 may control an operation of the scan driver 140 by providing the scan control signal SCTRL to the scan driver 140. The controller 160 may control an operation of the power management circuit 150 by providing the power management control signal PCTRL to the power management circuit 150.

In some embodiments, the controller 160 may receive the input image data IDAT from the external host processor at the variable frame frequency VFF. For example, the variable frame frequency VFF may vary from a minimum frame frequency of about 60 Hz to a maximum frame frequency of about 360 Hz, but the present disclosure is not limited thereto. Further, the controller 160 may provide the output image data ODAT to the data driver 130 at the variable frame frequency VFF, and may provide the scan start signal to the scan driver 140 at the variable frame frequency VFF. Accordingly, the panel driver 120 may drive the display panel 110 at the variable frame frequency VFF. In some embodiments, a mode of the display device 100 that drives the display panel 110 at the variable frame frequency VFF (e.g., a variable refresh rate (VRR)) may be referred to as a variable frame mode. For example, the variable frame mode may be a Free-Sync mode, a G-Sync mode, or the like, but the present disclosure is not limited thereto.

In the variable frame mode, an active period of each frame period may have a constant or substantially constant time length, but a time length of a blank period of the frame period may be changed. For example, as illustrated in FIG. 3A, regardless of the variable frame frequency VFF, each frame period MIN_FP and MAX_FP may have an active period AP having the constant or substantially constant time length. However, when the variable frame frequency VFF is the maximum frame frequency MAX_FF of about 360 Hz, a blank period BP of a minimum frame period MIN_FP corresponding to the maximum frame frequency MAX_FF may be a default blank period DBP. As another example, when the variable frame frequency VFF is the minimum frame frequency MIN_FF of about 60 Hz, a blank period BP′ of a maximum frame period MAX_FP corresponding to the minimum frame frequency MIN_FF may be increased in a time length from the default blank period DBP. In other words, the blank period BP′ of the maximum frame period MAX_FP may include the default blank period DBP, as well as an additional blank period ABP.

In a case where the light emitting elements EL of the plurality of pixels PX are initialized in the active period AP, but are not initialized in the blank period BP′ in the variable frame mode in which the display panel 110 is driven at the variable frame frequency VFF, the display panel 110 may have a luminance deviation (e.g., a luminance variation) according to the variable frame frequency VFF. In this case, for example, as illustrated in FIG. 3B, during the same time (e.g., about 33 ms), each light emitting element EL of the display panel 100 driven at the minimum frame frequency MIN_FF of about 60 Hz may be initialized (e.g., may be turned off) about 2 times, and each light emitting element EL of the display panel 100 driven at the maximum frame frequency MAX_FF of about 360 Hz may be initialized (e.g., may be turned off) about 12 times. Accordingly, an average luminance AVGLUM2 of the display panel 110 driven at the maximum frame frequency MAX_FF of about 360 Hz may be lower than an average luminance AVGLUM1 of the display panel 100 driven at the minimum frame frequency MIN_FF of about 60 Hz.

On the other hand, to reduce the luminance deviation of the display panel 110 according to the variable frame frequency VFF, the panel driver 120 may perform an active scan operation in the active period of the frame period, as well as an initialization scan operation in the blank period of the frame period when the variable frame frequency VFF is lower than the maximum frame frequency MAX_FF. The active scan operation may be an operation of initializing the light emitting elements EL of the plurality of pixels PX, while providing the data voltages VDAT to the plurality of pixels PX. The initialization scan operation may be an operation of initializing the light emitting elements EL of the plurality of pixels PX, without providing the data voltages VDAT to the plurality of pixels PX. In some embodiments, because the initialization scan operation may not provide the data voltages VDAT to the plurality of pixels PX, the initialization scan operation may be referred to as a dummy scan operation.

For example, as illustrated in FIG. 4A, in a case where the display panel 110 includes N rows of the pixels PX (e.g., where N is an integer greater than 1), in an active period AP1 and AP2 of each of first and second frame periods FP1 and FP2, the scan driver 140 may perform the active scan operation ASCAN that sequentially provides first through N-th scan signals SC1, SC2, . . . , SCN to the plurality of pixels PX on a row-by-row basis, and that sequentially provides first through N-th initialization signals SI1, SI2, . . . , SIN to the plurality of pixels PX on a row-by-row basis. In other words, in each active period AP1 and AP2, the scan signal SC and the initialization signal SI may be provided to each of the pixels PX, the data voltage VDAT may be provided to each of the pixels PX in response to the scan signal SC, and the light emitting element EL of each of the pixels PX may be initialized or turned off in response to the initialization signal SI.

A blank period BP1 of the first frame period FP1 corresponding to the variable frame frequency VFF that is the maximum frame frequency MAX_FF of about 360 Hz may be the default blank period DBP, and the initialization scan operation ISCAN may not be performed in the blank period BP1 of the first frame period FP1. However, a blank period BP2 of the second frame period FP2 corresponding to the variable frame frequency VFF of about 180 Hz that is lower than the maximum frame frequency MAX_FF of about 360 Hz may include the default blank period DBP and the additional blank period ABP. Further, in the blank period BP2 of the second frame period FP2, the scan driver 140 may perform the initialization scan operation ISCAN that does not provide the first through N-th scan signals SC1, SC2, . . . , SCN to the plurality of pixels PX, and that sequentially provides the first through N-th initialization signals SI1, SI2, . . . , SIN to the plurality of pixels PX on the row-by-row basis. For example, as illustrated in FIG. 4A, the scan driver 140 may perform or initiate the initialization scan operation ISCAN at a start time point of the additional blank period ABP. Thus, in the blank period BP2 of the second frame period FP2, only the initialization signal SI may be provided to each of the pixels PX, the data voltage VDAT may not be provided to each of the pixels PX, and the light emitting element EL of each of the pixels PX may be initialized or turned off in response to the initialization signal SI.

However, even if the initialization scan operation ISCAN is performed in the blank period BP2, in a case where the panel driver 120 initiates the initialization scan operation ISCAN for each minimum frame period MIN_FP corresponding to the maximum frame frequency MAX_FF in each frame period FP2, the display panel 110 may still have the luminance deviation according to the variable frame frequency VFF. For example, as illustrated in FIG. 4B, in first, second, and fourth frame periods FP1, FP2, and FP4 corresponding to the variable frame frequency VFF that is 1/M of the maximum frame frequency MAX_FF (where M is an integer greater than 0), or in the first, second, and fourth frame periods FP1, FP2, and FP4 that are M times of the minimum frame period MIN_FP corresponding to the maximum frame frequency MAX_FF, the display panel 110 may have the same or substantially the same luminance. However, in a third frame period FP3 that is not M times (e.g., that is not an integer multiple) of the minimum frame period MIN_FP, the luminance of the display panel 110 may be decreased by the initialization scan operation ISCAN when compared with the luminance of the display panel 110 in the first, second, and fourth frame periods FP1, FP2, and FP4 that are M times of the minimum frame period MIN_FP. In other words, the number of initialization (e.g., the number of the turning off) of the light emitting element EL per unit time (e.g., one second) in a case where the variable frame frequency VFF is not 1/M of the maximum frame frequency MAX_FF may be increased compared with the number of initialization of the light emitting element EL per unit time in a case where the variable frame frequency VFF is equal to 1/M of the maximum frame frequency MAX_FF, and thus, the luminance of the display panel 110 may be decreased.

However, in the display device 100 according to some embodiments of the present disclosure, to reduce the luminance change in the case where the variable frame frequency VFF is not 1/M of the maximum frame frequency MAX_FF, a time interval from a start time point of a frame period to a time point at which the initialization scan operation ISCAN is performed or initiated may be different from the time length of the minimum frame period MIN_FP corresponding to the maximum frame frequency MAX_FF. In the examples of FIGS. 4A and 4B where the panel driver 120 performs or initiates the initialization scan operation ISCAN for each minimum frame period MIN_FP corresponding to the maximum frame frequency MAX_FF in each frame period, the initialization scan operation ISCAN may be performed or initiated at an end time point of the default blank period DBP or at a start time point of the additional blank period ABP. However, in the display device 100 according to some embodiments, the initialization scan operation ISCAN may not be performed or initiated at the start time point of the additional blank period ABP. For example, in the display device 100 according to some embodiments, when the variable frame frequency VFF is lower than the maximum frame frequency MAX_FF, the initialization scan operation ISCAN may be performed or initiated after a suitable time (e.g., a predetermined time) from the start time point of the additional blank period ABP has lapsed.

For example, as illustrated in FIG. 5, in a case where the panel driver 120 performs the active scan operation ASCAN at the start time point of the frame period FP, or at the start time point of the active period AP, and performs or initiates the initialization scan operation ISCAN for each minimum frame period MIN_FP, an initialization signal SI′ may be applied to each pixel PX in a first pixel row of the display panel 110 at the start time point of the active period AP, and the initialization signal SI′ may be again applied to the pixel PX at each minimum frame period MIN_FP. In this case, when the variable frame frequency VFF is not 1/M of the maximum frame frequency MAX_FF, a time interval from when the initialization signal SI′ is lastly applied to the pixel PX in a frame period FP to when the initialization signal SI′ is first applied to the pixel PX in the next frame period FP may be shorter than the time length of the minimum frame period MIN_FP, and thus, the luminance of the display panel 110 may be decreased in the frame period FP.

However, in the display device 100 according to some embodiments, to prevent or substantially prevent the decrease in luminance, the initialization scan operation ISCAN may not be performed at a start time point TP0 of the additional blank period ABP, and a first initialization scan operation ISCAN1 may be performed or initiated after the time (e.g., the time of the minimum frame period MIN_FP) from the start time point TP0 of the additional blank period ABP has lapsed. In other words, the time interval TI from the start time point of the frame period FP to the time point at which the first initialization scan operation ISCAN1 is performed or initiated may be different from the time length of the minimum frame period MIN_FP corresponding to the maximum frame frequency MAX_FF.

To perform the operation, the controller 160 of the panel driver 120 may include a frame counter 170 (e.g., a blank counter) that counts the duration of the frame period FP. Further the panel driver 120 may skip the initialization scan operation ISCAN when the duration of the frame section FP becomes the time length of the minimum frame period MIN_FP, and may perform or initiate the initialization scan operations ISCAN1 and ISACN2 when the duration of the frame period FP becomes K times of the time length of the minimum frame period MIN_FP, where K is an integer greater than 1. For example, as illustrated in FIG. 5, the panel driver 120 may perform the first initialization scan operation ISCAN1 by providing an initialization signal SI at a first blank initialization time point BITP1 at which the duration of the frame period FP becomes two times of the time length of the minimum frame period MIN_FP, and may perform a second initialization scan operation ISCAN2 by providing the initialization signal SI at a second blank initialization time point BITP2 at which the duration of the frame period FP becomes three times of the time length of the minimum frame period MIN_FP. Accordingly, because the initialization scan operation ISCAN may be skipped when the duration of the frame section FP becomes the time length of the minimum frame section MIN_FP, the luminance decrease of the display panel 110 may be prevented or substantially prevented.

In other embodiments, as illustrated in FIG. 6, a cycle (e.g., a period) of the initialization scan operations ISCAN1, ISCAN2, ISCAN3, ISCAN4, and ISCAN5 within the blank period BP may not be constant. In other words, in the display device 100 according to some embodiments, blank initialization time points BITP1, BITP2, BITP3, BITP4, and BITP5 may be determined and stored, and the initialization scan operations ISCAN1, ISCAN2, ISCAN3, ISCAN4, and ISCAN5 may be performed or initiated when the duration of the frame period FP becomes the stored blank initialization time points BITP1, BITP2, BITP3, BITP4, and BITP5.

To perform the operation, the controller 160 of the panel driver 120 may include the frame counter 170 (e.g., the blank counter) that counts the duration of the frame section FP, and a blank initialization storage 180 that stores the blank initialization time points BITP1, BITP2, BITP3, BITP4, and BITP5 at which the initialization scan operations ISCAN1, ISCAN2, ISCAN3, ISCAN4, and ISCAN5 are performed or initiated within the blank period BP. In some embodiments, the blank initialization time points BITP1, BITP2, BITP3, BITP4, and BITP5 at which the initialization scan operations ISCAN1, ISCAN2, ISCAN3, ISCAN4, and ISCAN5 are performed within the blank period BP may be determined, such that the deviation (e.g., the variation) in the number of times the light emitting elements EL are initialized per unit time (e.g., one second) as the variable frame frequencies VFF changes may be minimized or reduced.

For example, as illustrated in FIG. 6, in a case where the maximum frame frequency MAX_FF is about 360 Hz, a first blank initialization time point BITP1 at which a first initialization scan operation ISCAN1 is performed may be determined corresponding to a frame frequency between about 230 Hz and about 240 Hz, a second blank initialization time point BITP2 at which a second initialization scan operation ISCAN2 is performed may be determined corresponding to a frame frequency between about 140 Hz and about 150 Hz, a third blank initialization time point BITP3 at which a third initialization scan operation ISCAN3 is performed may be determined corresponding to a frame frequency between about 110 Hz and about 120 Hz, a fourth blank initialization time point BITP4 at which a fourth initialization scan operation ISCAN4 is performed may be determined corresponding to a frame frequency between about 80 Hz and about 90 Hz, and a fifth blank initialization time point BITP5 at which a fifth initialization scan operation ISCAN5 is performed may be determined corresponding to a frame frequency between about 60 Hz and about 70 Hz. Further, in some embodiments, the blank initialization time points BITP1, BITP2, BITP3, BITP4, and BITP5 may be adjusted (e.g., may be finely adjusted) by measuring the luminance of the display panel 110 while changing the variable frame frequency VFF.

Further, the panel driver 120 may perform or initiate the initialization scan operations ISCAN1, ISCAN2, ISCAN3, ISCAN4, and ISCAN5 when the duration of the frame period FP counted by the frame counter 170 becomes the blank initialization time points BITP1, BITP2, BITP3, BITP4, and BITP5 stored in the blank initialization storage 180. For example, as illustrated in FIG. 6, the panel driver 120 may perform or initiate the first initialization scan operation ISCAN1 at the first blank initialization time point BITP1 that is determined corresponding to the frame frequency between about 230 Hz and about 240 Hz. In other words, a first time interval TI1 from the start time point of the frame period FP to the first blank initialization time point BITP1 at which the first initialization scan operation ISCAN1 is performed may have a time length of a frame period corresponding to the frame frequency between about 230 Hz and about 240 Hz. Thus, the first time interval TI1 from the start time point of the frame period FP to the first blank initialization time point BITP1 at which the first initialization scan operation ISCAN1 is performed may be different from the time length of the minimum frame period MIN_FP corresponding to the maximum frame frequency MAX_FF.

Further, the panel driver 120 may perform or initiate the second initialization scan operation ISCAN2 at the second blank initialization time point BITP2 that is determined corresponding to the frame frequency between about 140 Hz and about 150 Hz. In other words, a second time interval TI2 from the start time point of the frame period FP to the second blank initialization time point BITP2 at which the second initialization scan operation ISCAN2 is performed may have a time length of a frame period corresponding to the frame frequency between about 140 Hz and about 150 Hz.

Further, the panel driver 120 may perform or initiate the third initialization scan operation ISCAN3 at the third blank initialization time point BITP3 that is determined corresponding to the frame frequency between about 110 Hz and about 120 Hz. In other words, a third time interval TI3 from the start time point of the frame period FP to the third blank initialization time point BITP3 at which the third initialization scan operation ISCAN3 is performed may have a time length of a frame period corresponding to the frame frequency between about 110 Hz and about 120 Hz.

Further, the panel driver 120 may perform or initiate the fourth initialization scan operation ISCAN4 at the fourth blank initialization time point BITP4 that is determined corresponding to the frame frequency between about 80 Hz and about 90 Hz. In other words, a fourth time interval TI4 from the start time point of the frame period FP to the fourth blank initialization time point BITP4 at which the fourth initialization scan operation ISCAN4 is performed may have a time length of a frame period corresponding to the frame frequency between about 80 Hz and about 90 Hz. Further, the panel driver 120 may perform or initiate the fifth initialization scan operation ISCAN5 at the fifth blank initialization time point BITP5 that is determined corresponding to the frame frequency between about 60 Hz and about 70 Hz. In other words, a fifth time interval TI5 from the start time point of the frame period FP to the fifth blank initialization time point BITP5 at which the fifth initialization scan operation ISCAN5 is performed may have a time length of a frame period corresponding to the frame frequency between about 60 Hz and about 70 Hz.

Accordingly, in some embodiments, the deviation in the number of times the light emitting elements EL are initialized during the unit time as the variable frame frequency VFF changes may be minimized or reduced, and the luminance deviation of the display panel 110 as the variable frame frequency VFF changes may be minimized or reduced.

In some embodiments, the blank initialization storage 180 may further store initialization voltage levels corresponding to the blank initialization time points BITP1, BITP2, BITP3, BITP4, and BITP5, respectively. Further, the panel driver 120 may adjust the initialization voltage VINT applied to the plurality of pixels PX based on the initialization voltage levels stored in the blank initialization storage 180, when the duration of the frame period FP counted by the frame counter 170 corresponds to the blank initialization time points BITP1, BITP2, BITP3, BITP4, and BITP5 stored in the blank initialization storage 180. Accordingly, the luminance deviation of the display panel 110 as the variable frame frequency VFF changes may be further reduced.

As described above, in the display device 100 according to some embodiments, the display panel 110 may be driven at the variable frame frequency VFF, the active scan operation ASCAN may be performed in the active period AP of the frame period FP, and the initialization scan operations ISCAN1, ISCAN2, ISCAN3, ISCAN4, and ISCAN5 may be performed in the blank period BP of the frame period FP. Further the time interval TI and TI1 from the start time point of the frame period FP to the time point at which the first initialization scan operation ISCAN1 is performed may be different from the time length of the minimum frame period MIN_FP corresponding to the maximum frame frequency MAX_FF of the variable frame frequency VFF. Accordingly, the luminance deviation of the display panel 110 due to a variation in the variable frame frequency VFF may be removed or reduced.

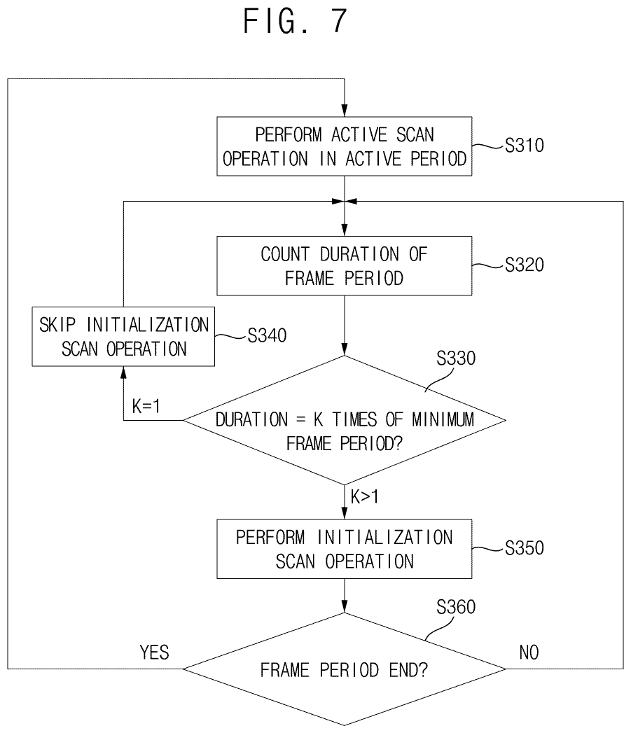

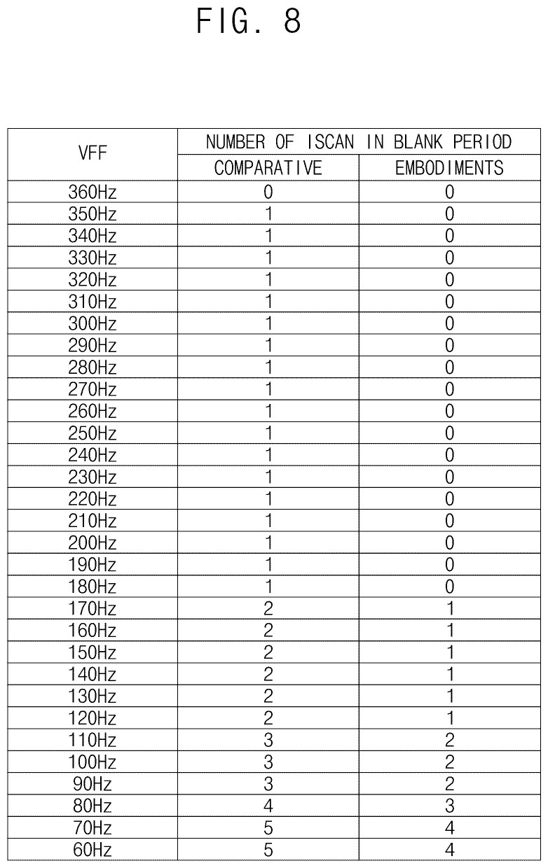

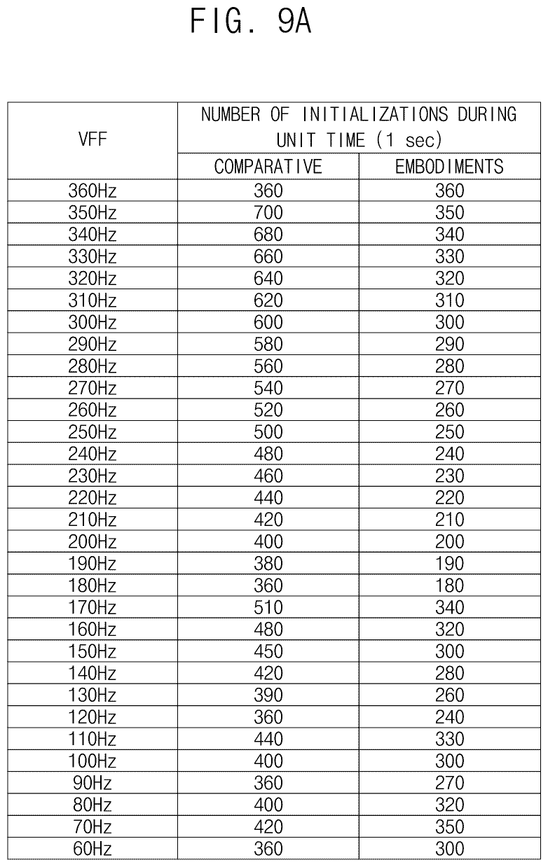

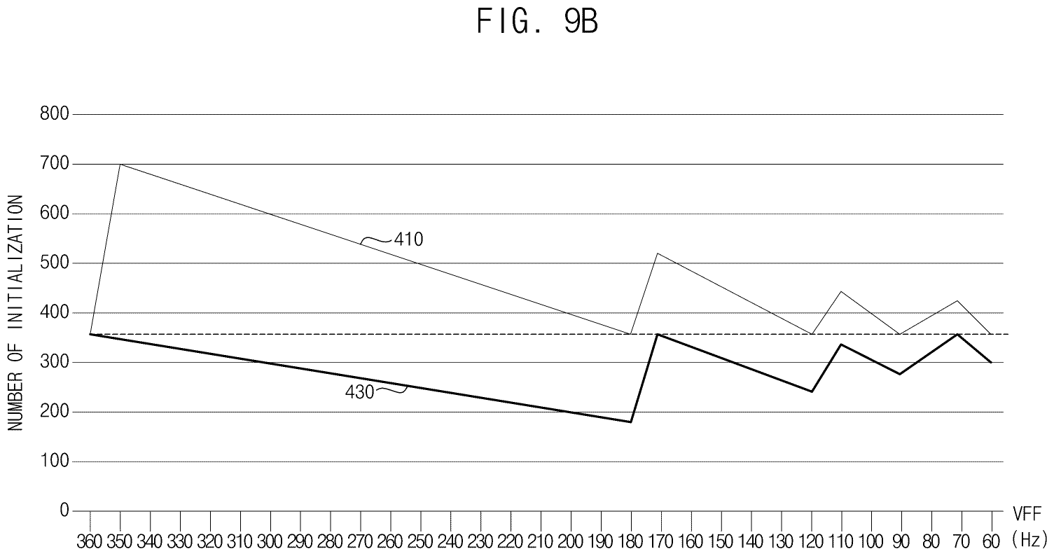

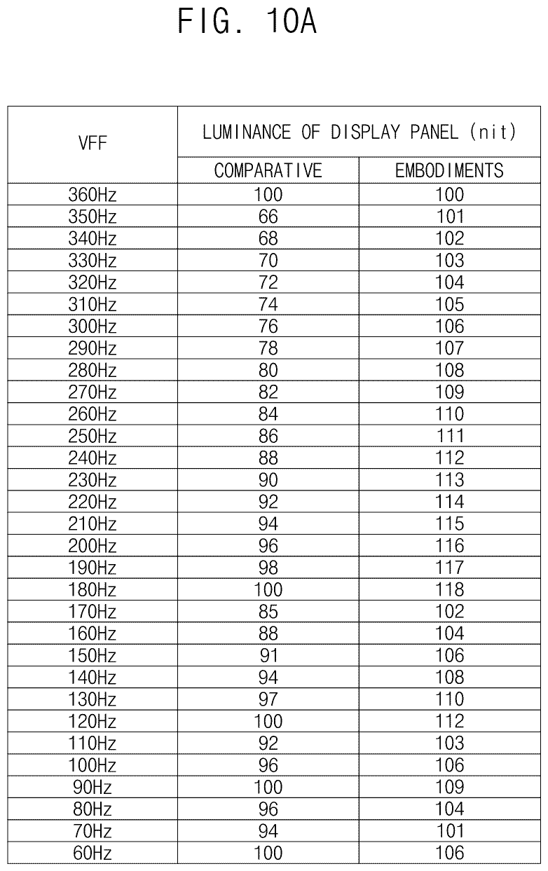

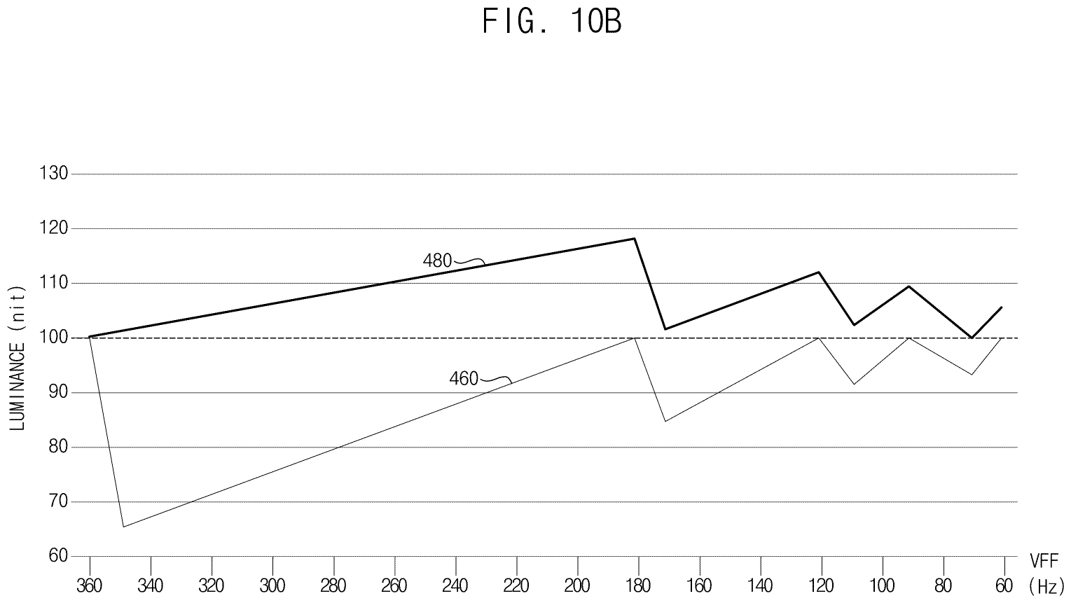

FIG. 7 is a flowchart illustrating a method of operating a display device according to one or more embodiments. FIG. 8 is a table illustrating an example of a number of initialization scan operations in each frame period according to a variable frame frequency. FIG. 9A is a table illustrating an example of a number of times a light emitting element is initialized per unit time according to a variable frame frequency. FIG. 9B is a graph illustrating an example of a number of times a light emitting element is initialized per unit time according to a variable frame frequency. FIG. 10A is a table illustrating an example of a luminance of a display panel according to a variable frame frequency. FIG. 10B is a graph showing an example of a luminance of a display panel according to a variable frame frequency.

Referring to FIGS. 1 and 7, in a method of operating a display device 100 according to some embodiments, a panel driver 120 may drive a display panel 110 including a plurality of pixels PX at a variable frame frequency VFF. The panel driver 120 may perform an active scan operation in an active period (S310). For example, in the active period of a frame period, the panel driver 120 may perform the active scan operation to initialize light emitting elements of the plurality of pixels PX, while providing data voltages VDAT to the plurality of pixels PX.

Further, in a blank period of the frame period, the panel driver 120 may perform an initialization scan operation to initialize the light emitting elements without providing the data voltages VDAT to the plurality of pixels PX (e.g., S320, S330, S340 and S350). In the method of operating the display device 100 according to some embodiments, a time interval from a start time point of the frame period to a time point at which the initialization scan operation is performed or initiated may be different from a time length of a minimum frame period corresponding to a maximum frame frequency of the variable frame frequency VFF.

In some embodiments, to perform the initialization scan operation in the blank period, a frame counter 170 of the panel driver 120 may count a duration of the frame period (S320). The frame counter 170 may compare the duration of the frame period with K times of the time length of the minimum frame period (S330), where K is an integer greater than 0. When the duration of the frame period is substantially equal to the time length of the minimum frame period (e.g., when K is equal to 1 at S330), the panel driver 120 may skip the initialization scan operation (S340). When the duration of the frame period is two or more times of the time length of the minimum frame period (e.g., when K is greater than 1 at S330), the panel driver 120 may perform the initialization scan operation (S350). If (e.g., when) the frame period has not ended (e.g., NO at 360), the initialization scan operation may be repeatedly performed. When the frame period ends (e.g., YES at S360), the active scan operation may be performed in a next frame period.

For example, as illustrated in FIG. 8, in a comparative display device in which the initialization scan operation is performed when the duration of the frame period is equal to an integer multiple of the time length of the minimum frame period, in each frame period, no initialization scan operation may be performed when the variable frame frequency VFF is about 360 Hz, the initialization scan operation may be performed once when the variable frame frequency VFF is about 350 Hz to about 180 Hz, the initialization scan operation may be performed twice when the variable frame frequency VFF is about 170 Hz to about 120 Hz, the initialization scan operation may be performed three times when the variable frame frequency VFF is about 110 Hz to about 90 Hz, the initialization scan operation may be performed four times when the variable frame frequency VFF is about 80 Hz, and the initialization scan operation may be performed five times when the variable frame frequency VFF is about 70 Hz to about 60 Hz. However, in the method of operating the display device 100 according to some embodiments, the initialization scan operation may be skipped when the duration of the frame period is equal to or substantially equal to the time length of the minimum frame period. Thus, in each frame period, no initialization scan operation may be performed when the variable frame frequency VFF is about 360 Hz to about 180 Hz, the initialization scan operation may be performed once when the variable frame frequency VFF is about 170 Hz to about 120 Hz, the initialization scan operation may be performed twice when the variable frame frequency VFF is about 110 Hz to about 90 Hz, the initialization scan operation may be performed three times when the variable frame frequency VFF is about 80 Hz, and the initialization scan operation may be performed four times when the variable frame frequency VFF is from about 70 Hz to about 60 Hz.

In this case, as illustrated in FIGS. 9A and 9B, in the comparative display device 410, during a unit time of about one second, the light emitting element of each pixel PX may be initialized about three hundred and sixty times at the variable frame frequency VFF of about 360 Hz, and may be initialized about seven hundred times at the variable frame frequency VFF of about 350 Hz. In other words, in the comparative display device 410, the number of initialization times of the light emitting element per unit time according to the variable frame frequency VFF may differ at maximum by about three hundred and forty times. However, in the method of operating the display device 100 according to some embodiments 430, during the unit time of about one second, the light emitting element of each pixel PX may be initialized about three hundred and sixty times at the variable frame frequency VFF of about 360 Hz, and may be initialized about one hundred and eighty times at the variable frame frequency VFF of about 180 Hz. Thus, in the method of operating the display device 100 according to some embodiments 430, the number of initialization times of the light emitting element per unit time according to the variable frame frequency VFF may differ at maximum by about one hundred and eighty times. In other words, in the method of operating the display device 100 according to some embodiments, a deviation (e.g., a variation) in the number of initializations of the light emitting element per unit time according to the variable frame frequency VFF may be reduced.

Further, in a case where a target luminance of the display panel 110 is about 100 nit, and a luminance of the display panel 110 is decreased by about 0.1 nit when the light emitting element is initialized, as illustrated in FIGS. 10A and 10B, in the comparative display device 460, the display panel 110 may have a luminance of about 100 nit at the variable frame frequency VFF of about 360 Hz, and may have a luminance of about 66 nit at the variable frame frequency VFF of about 350 Hz. In other words, in the comparative display device 460, the display panel 110 may have a luminance difference of about 34 nit depending on the variable frame frequency VFF. However, in the method of operating the display device 100 according to some embodiments 480, the display panel 110 may have a luminance of about 100 nit at the variable frame frequency VFF of about 360 Hz, and may have a luminance of about 118 nit at the variable frame frequency VFF of about 180 Hz. Thus, in the method of operating the display device 100 according to some embodiments 480, the display panel 110 may have a luminance difference of about 18 nit depending on the variable frame frequency VFF. In other words, in the method of operating the display device 100 according to some embodiments, a luminance deviation (e.g., a luminance variation) of the display panel 110 according to the variable frame frequency VFF may be reduced.

As described above, in the method of operating the display device 100 according to some embodiments, the initialization scan operation may be skipped when the duration of the frame period becomes (e.g., equal to) the time length of the minimum frame period. Accordingly, a deviation (e.g., a variation) in the number of initializations of the light emitting element per unit time according to the variable frame frequency VFF may be reduced, and the deviation (e.g., the variation) in a luminance of the display panel 110 according to the variable frame frequency VFF may be reduced.

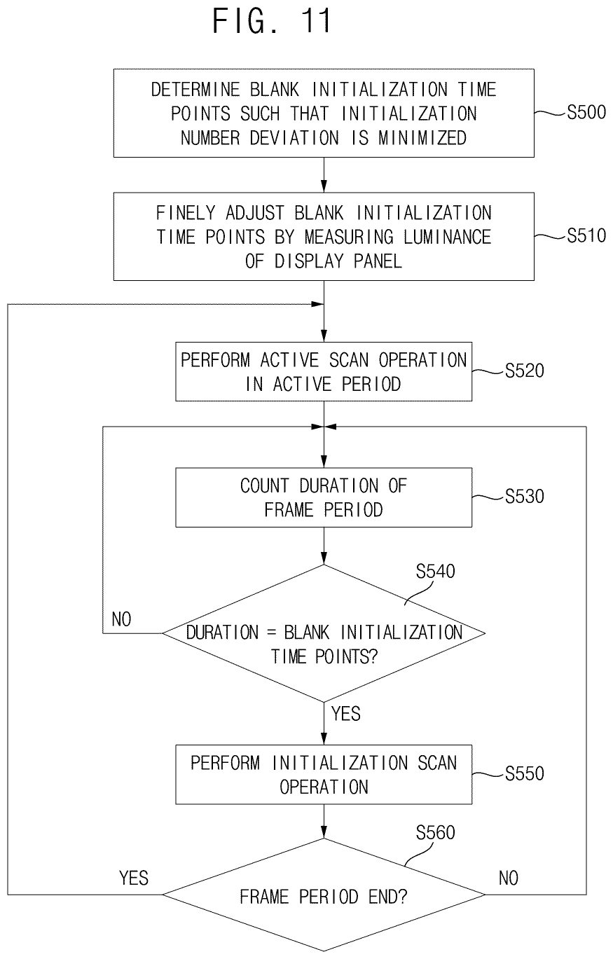

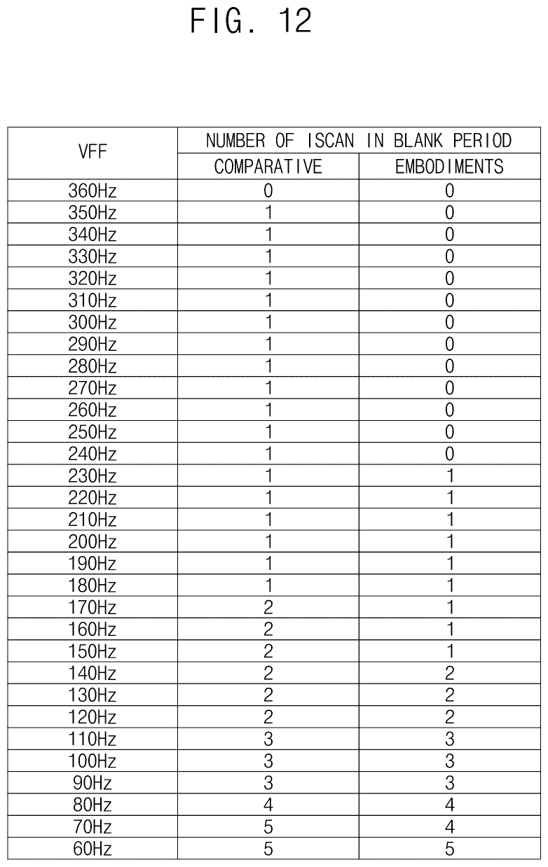

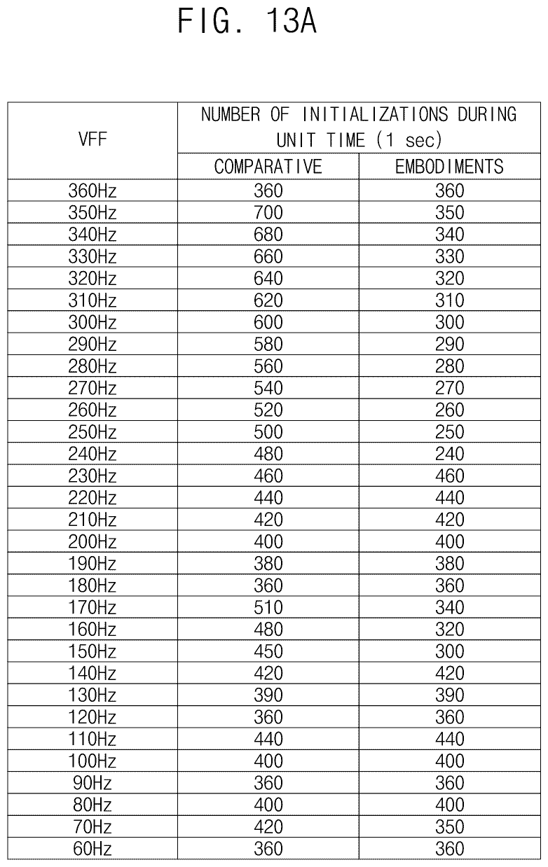

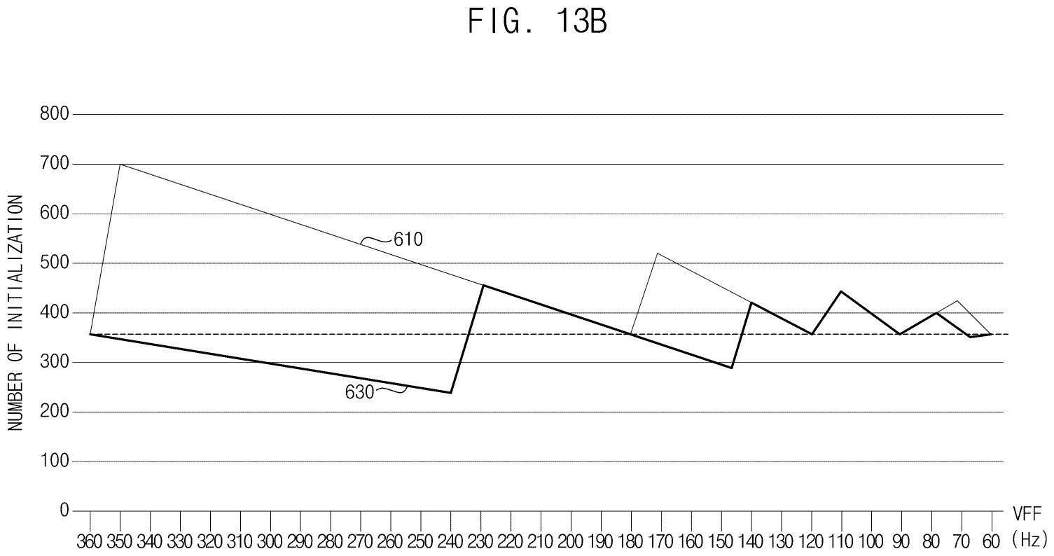

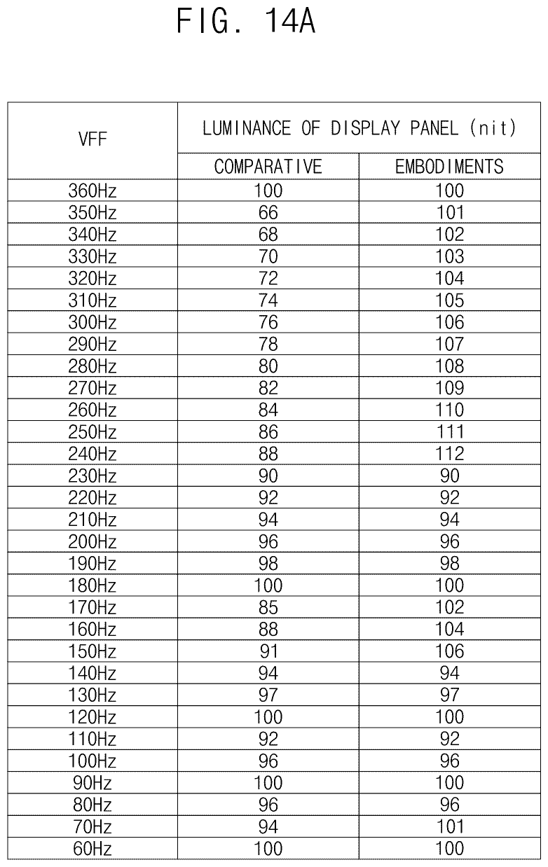

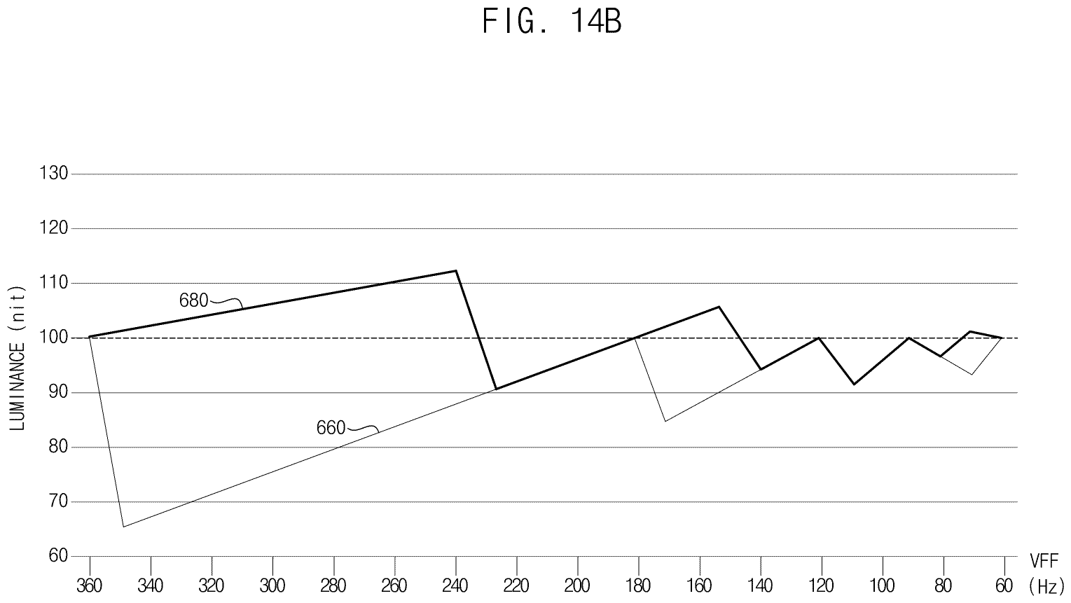

FIG. 11 is a flowchart illustrating a method of operating a display device according to one or more embodiments. FIG. 12 is a table illustrating an example of a number of initialization scan operations in each frame period according to a variable frame frequency. FIG. 13A is a table illustrating an example of a number of times a light emitting element is initialized per unit time according to a variable frame frequency. FIG. 13B is a graph illustrating an example of a number of times a light emitting element is initialized per unit time according to a variable frame frequency. FIG. 14A is a table illustrating an example of a luminance of a display panel according to a variable frame frequency. FIG. 14B is a graph showing an example of a luminance of a display panel according to a variable frame frequency.

Referring to FIGS. 1 and 11, in a method of operating a display device 100 according to some embodiments, blank initialization time points at which an initialization scan operation is performed within a blank period may be determined, such that initialization number of deviations (e.g., variations) are minimized or reduced (S500), and a blank initialization storage 180 of a panel driver 120 may store the determined blank initialization time points. The blank initialization time points may be determined so that, as a variable frame frequency VFF changes, the deviation (e.g., the initialization number of deviations) in the number of times the light emitting elements of a plurality of pixels PX are initialized per unit time (e.g., one second) may be minimized or reduced.

For example, as illustrated in FIG. 6, when a maximum frame frequency of the variable frame frequency VFF is about 360 Hz, a first blank initialization time point BITP1 at which a first initialization scan operation is performed may be determined corresponding to a frame frequency between about 230 Hz and about 240 Hz, a second blank initialization time point BITP2 at which a second initialization scan operation is performed may be determined corresponding to a frame frequency between about 140 Hz and about 150 Hz, a third blank initialization time point BITP3 at which a third initialization scan operation is performed may be determined corresponding to a frame frequency between about 110 Hz and about 120 Hz, a fourth blank initialization time point BITP4 at which a fourth initialization scan operation is performed may be determined corresponding to a frame frequency between about 80 Hz and about 90 Hz, and a fifth blank initialization time point BITP5 at which a fifth initialization scan operation is performed may be determined corresponding to a frame frequency between about 60 Hz and about 70 Hz. Further, in some embodiments, the blank initialization time points BITP1, BITP2, BITP3, BITP4, and BITP5 may be finely adjusted by measuring a luminance of a display panel 110 (S510), while changing the variable frame frequency VFF.

In an active period of a frame period, the panel driver 120 may perform an active scan operation (S520) to initialize the light emitting elements of the plurality of pixels PX while providing data voltages VDAT to the plurality of pixels PX.

Further, in the blank period of the frame period, the panel driver 120 may perform the initialization scan operation to initialize the light emitting elements without providing the data voltages VDAT to the plurality of pixels PX (e.g., S530, S540, and S550). In the method of operating the display device 100 according to some embodiments, a time interval from a start time point of the frame period to a time point at which the initialization scan operation is performed or initiated may be different from a time length of a minimum frame period corresponding to a maximum frame frequency of the variable frame frequency VFF.

In some embodiments, to perform the initialization scan operation in the blank period, a frame counter 170 of the panel driver 120 may count a duration of the frame period (S530). The frame counter 170 may compare the duration of the frame period with the blank initialization time points BITP1, BITP2, BITP3, BITP4, and BITP5 (S540) stored in the blank initialization storage 180. When the duration of the frame period is different from the blank initialization time points BITP1, BITP2, BITP3, BITP4. and BITP5 (e.g., NO at S540), the panel driver 120 may not perform the initialization scan operation, and may continuously count the duration of the frame period (S530). When the duration of the frame period corresponds to the blank initialization time points BITP1, BITP2, BITP3, BITP4, and BITP5 (e.g., YES at S540), the panel driver 120 may perform the initialization scan operation (S550). If (e.g., when) the frame period has not ended (e.g., NO at S560), the initialization scan operation may be repeatedly performed. As another example, when the frame period ends (e.g., YES at S560), the active scan operation may be performed in a next frame period (S520).

As described above, in the method of operating the display device 100 according to some embodiments, the blank initialization time points BITP1, BITP2, BITP3, BITP4, and BITP5 may be determined, such that the initialization number deviation (e.g., the initialization number variation) according to the variable frame frequency VFF is minimized or reduced. Thus, for example, in the method of operating the display device 100 according to some embodiments, in each frame period, as illustrated in FIG. 12, no initialization scan operation may be performed when the variable frame frequency VFF is about 360 Hz to about 240 Hz, the initialization scan operation may be performed once when the variable frame frequency VFF is about 230 Hz to about 150 Hz, the initialization scan operation may be performed twice when the variable frame frequency VFF is about 140 Hz to about 120 Hz, the initialization scan operation may be performed three times when the variable frame frequency VFF is about 110 Hz to about 90 Hz, the initialization scan operation may be performed four times when the variable frame frequency VFF is about 80 Hz to about 70 Hz, and the initialization scan operation may be performed five times when the variable frame frequency VFF is about 60 Hz.

In this case, as illustrated in FIGS. 13A and 13B, in a comparative display device 610, the number of initialization times of the light emitting element per unit time (e.g., about one second) according to the variable frame frequency VFF may differ at maximum by about three hundred and forty times. However, in the method of operating the display device 100 according to some embodiments 630, during the unit time of about one second, the light emitting element of each pixel PX may be initialized about three hundred and sixty times at the variable frame frequency VFF of about 360 Hz, may be initialized about two hundred and forty times at the variable frame frequency VFF of about 240 Hz, and may be initialized about four hundred and sixty times at the variable frame frequency VFF of about 230 Hz. Thus, in the method of operating the display device 100 according to some embodiments 630, the number of initialization times of the light emitting element per unit time according to the variable frame frequency VFF may differ at maximum by about one hundred and eighty times. In other words, in the method of operating the display device 100 according to some embodiments, a deviation (e.g., a variation) in the number of initializations of the light emitting element per unit time according to the variable frame frequency VFF may be reduced.

Further, in a case where a target luminance of the display panel 110 is about 100 nit, and a luminance of the display panel 110 is decreased by about 0.1 nit when the light emitting element is initialized, as illustrated in FIGS. 14A and 14B, in the comparative display device 660, the display panel 110 may have a luminance difference of about 34 nit depending on the variable frame frequency VFF. However, in the method of operating the display device 100 according to some embodiments 680, the display panel 110 may have a luminance of about 100 nit at the variable frame frequency VFF of about 360 Hz, may have a luminance of about 112 nit at the variable frame frequency VFF of about 240 Hz, and may have a luminance of about 90 nit at the variable frame frequency VFF of about 230 Hz. Thus, in the method of operating the display device 100 according to some embodiments 680, the display panel 110 may have a luminance difference of about 22 nit depending on the variable frame frequency VFF. In other words, in the method of operating the display device 100 according to some embodiments, a luminance deviation (e.g., a luminance variation) of the display panel 110 according to the variable frame frequency VFF may be reduced.

As described above, in the method of driving the display device 100 according to some embodiments, the blank initialization time points BITP1, BITP2, BITP3, BITP4, and BITP5 may be determined, such that the deviation in the number of initializations of the light emitting element per unit time according to the variable frame frequency VFF may be minimized or reduced. Accordingly, the deviation in the number of initializations of the light emitting element per unit time according to the variable frame frequency VFF may be reduced, and the deviation in luminance of the display panel 110 according to the variable frame frequency VFF may be reduced.

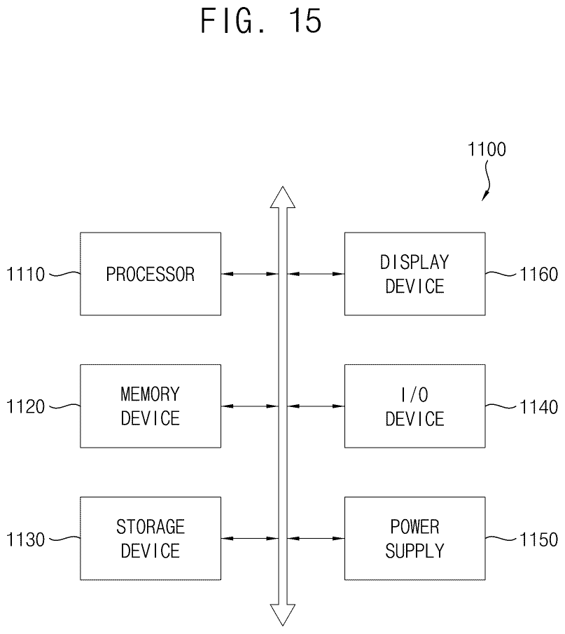

FIG. 15 is a block diagram illustrating an electronic device including a display device according to one or more embodiments.

Referring to FIG. 15, an electronic device 1100 may include a processor 1110, a memory device 1120, a storage device 1130, an input/output (I/O) device 1140, a power supply 1150, and a display device 1160. The electronic device 1100 may further include a plurality of ports for communicating with a video card, a sound card, a memory card, a universal serial bus (USB) device, other electric devices, and/or the like.

The processor 1110 may perform various computing functions or tasks. The processor 1110 may be an application processor (AP), a micro-processor, a central processing unit (CPU), and/or the like. The processor 1110 may be coupled to other components via an address bus, a control bus, a data bus, and/or the like. Further, in some embodiments, the processor 1110 may be further coupled to an extended bus, such as a peripheral component interconnection (PCI) bus.

The memory device 1120 may store data for the operations of the electronic device 1100. For example, the memory device 1120 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like, and/or at least one volatile memory device, such as a dynamic random access memory (DRAM) device, a static random access memory (SRAM) device, a mobile dynamic random access memory (mobile DRAM) device, or the like.

The storage device 1130 may be a solid state drive (SSD) device, a hard disk drive (HDD) device, a CD-ROM device, and/or the like. The I/O device 1140 may be an input device, such as a keyboard, a keypad, a mouse, a touch screen, and/or the like, and an output device, such as a printer, a speaker, and/or the like. The power supply 1150 may supply power for the operations of the electronic device 1100. The display device 1160 may be coupled to other components through the buses or other communication links.

In the display device 1160, a display panel may be driven at a variable frame frequency, an active scan operation may be performed in an active period of a frame period, and an initialization scan operation may be performed in a blank period of the frame period. Further, in the display device 1160, a time interval from a start time point of the frame period to a time point at which the initialization scan operation is performed or initiated may be different from a time length of a minimum frame period corresponding to a maximum frame frequency of the variable frame frequency. Accordingly, in the display device 1160, a luminance deviation (e.g., a luminance variation) due to variation in the variable frame frequency may be removed or reduced.

One or more embodiments of the present disclosure described above may be applied to any suitable kind of display device 1160, and any suitable kind of electronic device 1100 including the display device 1160. For example, one or more of the embodiments may be applied to a smart phone, a wearable electronic device, a tablet computer, a mobile phone, a television (TV), a digital TV, a 3D TV, a personal computer (PC), a home appliance, a laptop computer, a personal digital assistant (PDA), a portable multimedia player (PMP), a digital camera, a music player, a portable game console, a navigation device, and/or the like.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A display device comprising:
a display panel comprising a plurality of pixels; and
a panel driver configured to drive the display panel at a variable frame frequency, and to:
in an active period of a frame period, perform an active scan operation to initialize light emitting elements of the plurality of pixels, while providing data voltages to the plurality of pixels, and
in a blank period of the frame period, perform an initialization scan operation to initialize the light emitting elements without providing the data voltages to the plurality of pixels,
wherein a time interval from a start time point of the frame period to a time point at which the initialization scan operation is performed is different from a time length of a minimum frame period corresponding to a maximum frame frequency of the variable frame frequency.

2. The display device of claim 1, wherein the active period has a constant time length, and
wherein the blank period comprises a default blank period when the variable frame frequency is the maximum frame frequency, and the blank period comprises the default blank period and an additional blank period when the variable frame frequency is lower than the maximum frame frequency.

3. The display device of claim 2, wherein, when the variable frame frequency is lower than the maximum frame frequency, the panel driver is configured to not perform the initialization scan operation at a start time point of the additional blank period.

4. The display device of claim 2, wherein, when the variable frame frequency is lower than the maximum frame frequency, the panel driver is configured to perform the initialization scan operation after a time has lapsed from a start time point of the additional blank period.

5. The display device of claim 1, wherein a cycle of the initialization scan operation within the blank period is not constant.

6. The display device of claim 1, wherein the panel driver is configured to determine blank initialization time points at which the initialization scan operation is performed within the blank period to reduce a variation in a number of times the light emitting elements are initialized per unit time as the variable frame frequency changes.

7. The display device of claim 6, wherein the maximum frame frequency is 360 Hz,
a first blank initialization time point at which the initialization scan operation is first performed from among the blank initialization time points corresponds to a frame frequency between 230 Hz and 240 Hz,
a second blank initialization time point at which the initialization scan operation is performed for a second time from among the blank initialization time points corresponds to a frame frequency between 140 Hz and 150 Hz,
a third blank initialization time point at which the initialization scan operation is performed for a third time from among the blank initialization time points corresponds to a frame frequency between 110 Hz and 120 Hz,
a fourth blank initialization time point at which the initialization scan operation is performed for a fourth time from among the blank initialization time points corresponds to a frame frequency between 80 Hz and 90 Hz, and
a fifth blank initialization time point at which the initialization scan operation is performed for a fifth time from among the blank initialization time points corresponds to a frame frequency between 60 Hz and 70 Hz.

8. The display device of claim 6, wherein the blank initialization time points are adjusted by measuring a luminance of the display panel.

9. The display device of claim 1, wherein each of the plurality of pixels comprises:
a capacitor comprising a first electrode connected to a gate node, and a second electrode connected to a source node;
a first transistor including a gate connected to the gate node, a drain configured to receive a first power supply voltage, and a source connected to the source node;
a second transistor configured to transfer a data voltage to the gate node in response to a scan signal;
a third transistor configured to transfer an initialization voltage to the source node in response to an initialization signal; and
a corresponding light emitting element from among the light emitting elements including an anode connected to the source node, and a cathode configured to receive a second power supply voltage.

10. The display device of claim 9, wherein, to perform the active scan operation in the active period, the panel driver is configured to provide the scan signal and the initialization signal to each of the plurality of pixels, and
wherein, to perform the initialization scan operation in the blank period, the panel driver is configured to provide the initialization signal to each of the plurality of pixels without providing the scan signal.

11. The display device of claim 1, wherein the panel driver comprises:
a frame counter configured to count a duration of the frame period; and
a blank initialization storage configured to store blank initialization time points at which the initialization scan operation is performed within the blank period, and
wherein the panel driver is configured to perform the initialization scan operation when the duration of the frame period counted by the frame counter corresponds to the blank initialization time points stored in the blank initialization storage.

12. The display device of claim 11, wherein the blank initialization storage is further configured to store initialization voltage levels corresponding to the blank initialization time points, respectively, and
wherein the panel driver is configured to adjust an initialization voltage applied to the plurality of pixels based on the initialization voltage levels stored in the blank initialization storage when the duration of the frame period counted by the frame counter corresponds to the blank initialization time points stored in the blank initialization storage.

13. A method of operating a display device to drive a display panel comprising a plurality of pixels at a variable frame frequency, the method comprising:
performing an active scan operation in an active period of a frame period to initialize light emitting elements of the plurality of pixels, while providing data voltages to the plurality of pixels; and
performing an initialization scan operation in a blank period of the frame period to initialize the light emitting elements without providing the data voltages to the plurality of pixels,
wherein a time interval from a start time point of the frame period to a time point at which the initialization scan operation is performed is different from a time length of a minimum frame period corresponding to a maximum frame frequency of the variable frame frequency.

14. The method of claim 13, wherein the active period has a constant time length, and
wherein the blank period comprises a default blank period when the variable frame frequency is the maximum frame frequency, and the blank period comprises the default blank period and an additional blank period when the variable frame frequency is lower than the maximum frame frequency.

15. The method of claim 14, wherein, when the variable frame frequency is lower than the maximum frame frequency, the initialization scan operation is not performed at a start time point of the additional blank period.

16. The method of claim 13, wherein a cycle of the initialization scan operation within the blank period is not constant.

17. The method of claim 13, wherein the performing of the initialization scan operation in the blank period comprises:
counting a duration of the frame period;
skipping the initialization scan operation when the duration of the frame period is equal to the time length of the minimum frame period; and
performing the initialization scan operation when the duration of the frame period is greater than or equal to K times of the time length of the minimum frame period, where K is an integer greater than 1.

18. The method of claim 13, further comprising:
determining blank initialization time points at which the initialization scan operation is performed within the blank period to reduce a variation in a number of times the light emitting elements are initialized per unit time as the variable frame frequency changes.

19. The method of claim 18, wherein the blank initialization time points are adjusted by measuring a luminance of the display panel.

20. The method of claim 18, wherein the performing of the initialization scan operation in the blank period comprises:
counting a duration of the frame period; and
performing the initialization scan operation when the duration of the frame period corresponds to the blank initialization time points.
